(19) United States
(12) Patent Application Publication
(10) Pub. No.: US 2015/0198239 A1
(43) Pub. Date: Jul. 16, 2015

(54) CONTROL SYSTEM FOR HYBRID POWERTRAIN

(71) Applicant: Caterpillar Inc., Peoria, IL (US)

(72) Inventors: Don M. Wilbur, JR., Manito, IL (US); David L. Dickrell, Washington, IL (US)

(73) Assignee: Caterpillar Inc., Peoria, IL (US)

(21) Appl. No.: 14/152,318

(22) Filed: Jan. 10, 2014

(51) Int. Cl. F16H 61/00

(52) U.S. Cl. CPC F16H 61/00; F16H 2061/0012; F16H 2061/0087

(57) ABSTRACT

A control system for a hybrid powertrain including a transmission and a hybrid system is provided. The control system includes a memory unit, and a controller. The memory unit is configured to store at least one shift map therein. The controller is coupled to the memory unit, the transmission, and the hybrid system. The controller is configured to receive an operating state of the transmission and the hybrid system. The controller is further configured to determine if the received operating state meets a gearshift criteria with the at least one shift map, and trigger one or more gearshifts in the transmission based on the determination.

### TECHNICAL FIELD

The present disclosure relates to a control system and more particularly to a control system for a hybrid powertrain.

### BACKGROUND

Hybrid powertrains may typically include a hybrid system and an engine system therein. In some cases, the hybrid system and the engine system may be obtained from different manufacturers and assembled to form the hybrid powertrain. The specifications of the engine systems and the hybrid systems may vary from one manufacturer to another.

However, a manufacturer of transmissions may find it difficult to supply the transmissions without prior knowledge of the specifications of the hybrid powertrain. In such an event, gearshifts in such transmissions may not occur based on pre-determined logics or strategies associated with the operation of the engine system and the hybrid system. Therefore, such transmissions may not be configured to allow optimum performance of the hybrid powertrain. Further, such transmissions may not be configured to synergistically transmit the power from the hybrid powertrain to a driveline or drivetrain.

U.S. Pat. No. 7,377,877 (hereinafter referred to as '877 patent) relates to a gearshift control apparatus for a hybrid vehicle. The gearshift control apparatus includes an engine, a transmission for changing the speed of rotation of the engine, and a motor for assisting the driving force of the engine. The assist torque maximum value of the motor is set higher when the gear position of the transmission is a predetermined gear position at which the transmission efficiency of the driving force is highest than when the gear position is any other gear position than the predetermined gear position. However, the gearshift control apparatus of the '877 patent is configured to operate with instantaneous parameters of the motor and may hence, cause upshifts in the transmission to occur too quickly in a given span of time.

### SUMMARY OF THE DISCLOSURE

In one aspect, the present disclosure provides a control system for a hybrid powertrain including a transmission and a hybrid system. The control system includes a memory unit, and a controller. The memory unit is configured to store at least one shift map therein. The controller is coupled to the memory unit, the transmission, and the hybrid system. The controller is configured to receive an operating state of the transmission and the hybrid system. The controller is further configured to determine if the received operating state meets a gearshift criteria with the at least one shift map, and trigger one or more gearshifts in the transmission based on the determination.

In another aspect, the present disclosure discloses a method of controlling gearshifts in the transmission of the hybrid powertrain. The method includes receiving an operating state of a transmission and a hybrid system. The method further includes determining if the received operating state meets a gearshift criteria with at least one shift map. The method further includes triggering one or more gearshifts in the hybrid powertrain based on the determination.

Other features and aspects of this disclosure will be apparent from the following description and the accompanying drawings.

### BRIEF DESCRIPTION OF THE DRAWINGS

FIG. 1 is an schematic view of an exemplary hybrid powertrain employing a control system of the present disclosure;

FIG. 2 is a shift map of the control system;

FIG. 3 is a method of controlling gearshifts in the hybrid powertrain; and

FIG. 4 is a flow-chart showing an exemplary configuration and working of the control system.

### DETAILED DESCRIPTION

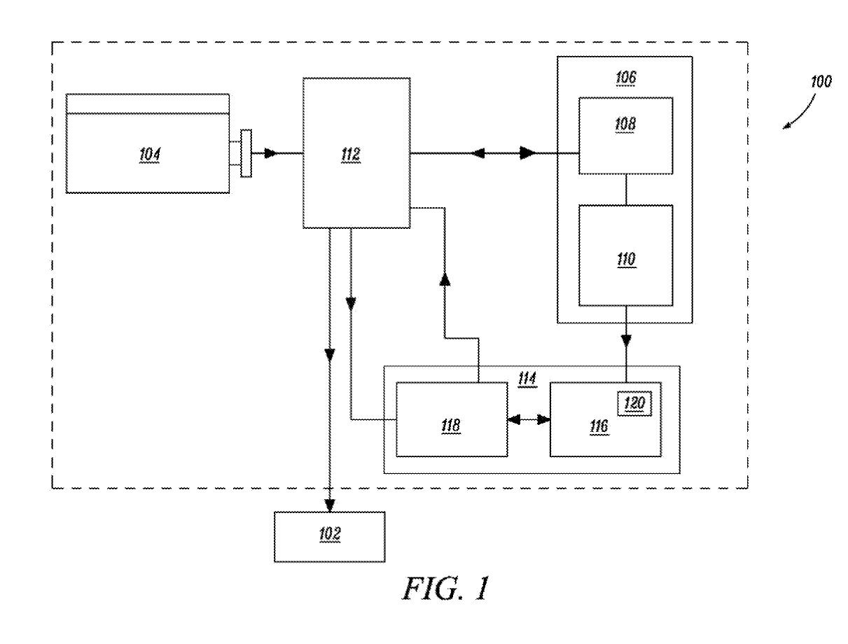

The present disclosure relates to a control system for a hybrid powertrain. FIG. 1 shows a perspective view of an exemplary hybrid powertrain 100 in which disclosed embodiments may be implemented. The hybrid powertrain 100 may be used to drive a machine (not shown) such as, but not limited to, a mining truck, an articulated truck, wheel loaders, skid loaders, motor graders, and the like. The hybrid powertrain 100 may transmit power to a driveline 102 of the machine. Driveline 102, disclosed herein, may include drive axles, shafts, couplings, differentials, wheels, tracks, and other power transmitting and/or locomotive implements employed to propel the machine on a ground surface.

The hybrid powertrain 100 may include an engine 104 therein. The engine 104 may be configured to combust fuel and deliver output power, for example, a diesel engine, a gasoline engine, a natural gas engine. Further, the engine 104 may be a reciprocating engine or a rotary engine. For example, the engine 104 may be a 6-cylinder in-line diesel engine, or a 12-cylinder V-type gasoline engine. It is to be noted that a type of engine disclosed herein is merely exemplary in nature and hence, non-limiting of this disclosure. The engine 104 may thus, include any type and configuration commonly known in the art to combust fuel and deliver output power therefrom.

The hybrid powertrain 100 may further include a hybrid system 106. The hybrid system 106, disclosed herein, is an electric power based driver component. The hybrid system 106 includes at least one motor/generator 108 and one or more electric power sources 110 electrically coupled thereto. The electric power sources 110 may include, for example, batteries, capacitors, alternators, generators or other devices that are typically known to provide a supply of electric power output therefrom. The motor/generator 108 may be configured to convert the electric power into mechanical energy for driving the driveline 102 and conversely convert mechanical energy into electric power for later use by the machine.

The hybrid powertrain 100 may further include a transmission 112 configured to receive power from the engine 104 and/or the hybrid system 106 and synergistically transmit the received power to and from the driveline 102 of the machine. Further, the transmission 112 may be configured to modulate an input speed or torque from the engine 104 and/or the hybrid powertrain 100 before delivering output power to the driveline 102. Therefore, the transmission 112 may be used to control output power to the driveline 102 and hence, modulate a final drive at wheels, tracks, or other locomotive implements of the machine. It should also be understood that while the motor/generator 108 is graphically shown connected to the transmission 112 it may also be positioned between the engine 104 and the transmission 112 as well.

The transmission 112 may be an automatic transmission 112 including, but not limited to, a continuously variable transmission 112 (CVT), an infinitely variable transmission 112 (IVT), or an electronically controlled CVT (E-CVT). However, in alternative embodiments, the transmission 112 may include other configurations such as hydrodynamic or hydrostatic configurations therein. Therefore, a type or configuration of the transmission 112 disclosed herein is merely exemplary in nature and hence, non-limiting of this disclosure. A person having ordinary skill in the art will acknowledge that in various embodiments of the present disclosure, the transmission 112 may be selected to include any type or configuration commonly known in the art.

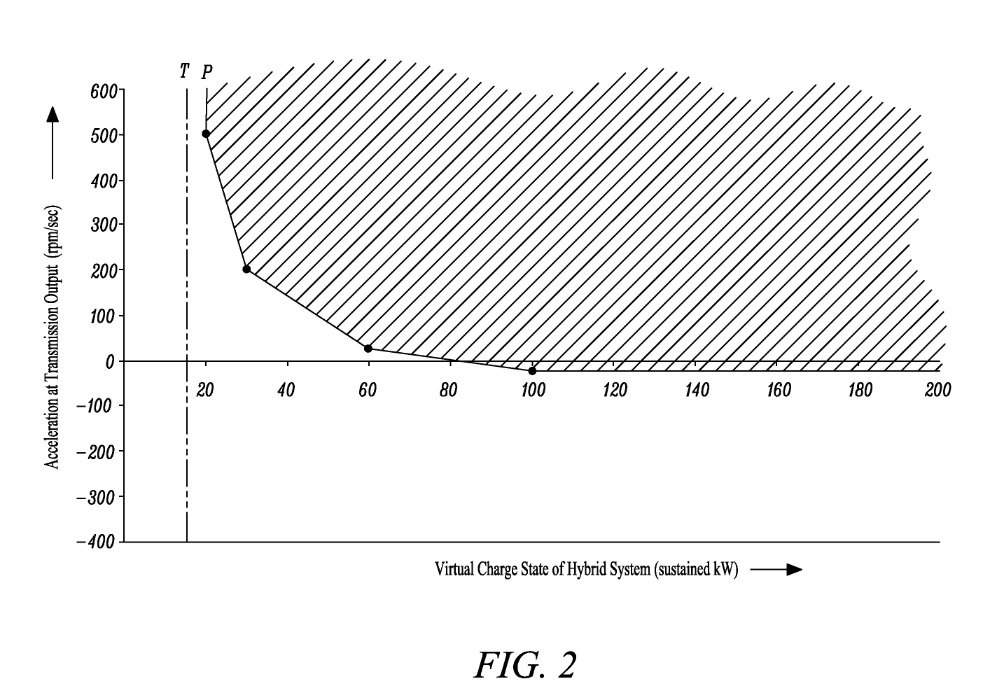

As shown in FIG. 1, the hybrid powertrain 100 employs a control system 114 for controlling gearshifts in the hybrid powertrain 100. More specifically, the control system 114 is configured to control gearshifts in the transmission 112 of the hybrid powertrain 100. The control system 114 of the present disclosure includes a memory unit 116 configured to store at least one shift map 120 therein. Explanation to the shift map 120 in accordance with an embodiment of the present disclosure will be made in conjunction with FIG. 2.

As shown in FIG. 2, the shift map 120 includes a plot P of acceleration at the transmission output versus virtual charge state of the hybrid system 106. As seen from FIG. 2, the acceleration at the transmission output is plotted in revolutions per minute per second (rpm/sec) along Y-axis while the virtual charge state of the hybrid system 106 is plotted as the maximum sustainable kilowatt for a specified pre-defined threshold time T (sustained kW) along X-axis. The plot P is representative of one or more threshold values corresponding to the acceleration at the transmission output and the virtual charge state of the hybrid system 106. Explanation pertaining to an operation of the control system 114 with use of the shift map 120 will be made hereinafter.

Turning back to FIG. 1, the control system 114 further includes a controller 118 coupled to the memory unit 116, the transmission 112, and the hybrid system 106. The controller 118 is configured to receive an operating state of the transmission 112 and the hybrid system 106. In an embodiment, the operating state of the hybrid system 106 may include a state of charge (SOC) of the hybrid system 106 as obtained from the hybrid system 106 during operation of the hybrid powertrain 100. The state of charge (SOC), disclosed herein, may be a peak power check for the hybrid system 106. For example, the controller 118 may be configured to determine a peak power check of the power sources 110 (i.e. batteries, capacitors, alternator, generator) and the motor/generator 108 and any other electric power sources 110 within the hybrid system 106.

In an embodiment, the operating state of the transmission 112 may include a rate of change of speed at the transmission output. Accordingly, the controller 118 may include one or more sensors (not shown) communicably coupled thereto. The sensors may measure the instantaneous speed from an output shaft of the transmission 112. In one example, the sensors may be configured to perform measurement of instantaneous speed at pre-defined time intervals. Alternatively, the sensors may be configured to perform the measurement of instantaneous speed continuously during an operation of the hybrid system 106. The controller 118 may be pre-programmed with various pre-defined routines, algorithms, or mathematical models to determine the rate of change of speed from the sensors.

The controller 118 is further configured to determine if the received operating state meets a gearshift criteria with the shift map 120. Thereafter, the controller 118 may trigger one or more gearshifts in the transmission 112 based on the determination. In an embodiment, the gearshift criteria may be the threshold value of acceleration at the transmission output presented by the shift map 120 (See FIG. 2). The gearshift criteria may be satisfied when the measured rate of change of speed at the transmission output is greater than an acceleration of the transmission output from the shift map 120.

Therefore, if the controller 118 determines that the rate of change of speed at the transmission output exceeds the threshold value of acceleration specified by the plot P of the shift map 120, the controller 118 may trigger a gearshift in the transmission 112. In a specific embodiment of the present disclosure, the controller 118 may be configured to trigger one or more upshifts in the transmission 112 and allow the hybrid powertrain 100 to power the driveline 102 with a higher gear position or a lower gear ratio in the transmission 112.

In an embodiment of the present disclosure, the controller 118 further determines if the operating state of the hybrid system 106 satisfies the gearshift criteria for a pre-defined threshold time T. As disclosed earlier herein, the operating state of the hybrid system 106 may include a peak power check of the hybrid system 106. The peak power check, disclosed herein, may represent a maximum power output level available from the electric power sources 110 of the hybrid system 106, for example, the batteries, alternator, generator or other electric power devices present in the hybrid system 106. Further, the pre-defined threshold time T, disclosed herein, may be in a range of 1 second to 99 seconds. In an embodiment as shown in FIG. 2, the pre-defined threshold time T may be 10 seconds. However, in other embodiment, the pre-defined threshold time T may be, for example, 15 seconds or 20 seconds.

With reference to the preceding embodiments, the gearshift criteria may be satisfied when the state of charge (SOC), i.e. the peak power check of the hybrid system 106 as obtained during operation of the hybrid system 106, exceeds the virtual charge state specified in the shift map 120 for the pre-defined threshold time T. Therefore, if the controller 118 determines that the peak power check or the maximum sustainable power output level available from the hybrid system 106 exceeds the virtual charge state of the shift map 120 for the pre-defined threshold time T, the controller 118 may trigger a gearshift in the transmission 112. Specifically, the controller 118 may trigger one or more upshifts in the transmission 112 and allow the hybrid powertrain 100 to power the driveline 102 with a higher gear position or a lower gear ratio in the transmission 112.

For example, consider that the transmission 112 operates with an initial gear ratio of 1:2.8 and the pre-defined threshold time T is set at 10 seconds. During operation of the hybrid powertrain 100, if the controller 118 determines that the state of charge (SOC), i.e. the peak power check of the hybrid system 106 as disclosed herein, is more than the virtual charge state of the shift map 120 for 10 seconds, then the controller 118 may trigger the upshift in the transmission 112 and cause a decrease in the gear ratio, for example, from 1:2.8 to 1:1.7. Conversely, if the controller 118 determines that the peak power check has not exceeded the virtual charge state of the shift map 120 for 10 seconds, then the controller 118 may not trigger an upshift in the transmission 112. In this case, the transmission 112 may continue to operate at the existing gear ratio, i.e. 1:2.8.

In an aspect of the present disclosure, it is envisioned to allow the upshift of gear position in the transmission 112 only when the peak power check exceeds the virtual charge state specified in the shift map 120 for the pre-defined threshold time T. Therefore, momentary spikes in the value of the peak power check that last for a time duration lesser than the pre-defined threshold time T may not configure the controller 118 into triggering an upshift. Therefore, if the batteries, alternator, generator or other electric power sources 110 or the motor/generator 108 of the hybrid system 106 do not present a peak power check capable of meeting a power demand of the machine for the pre-defined threshold time T, then the controller 118 does not perform the upshift in the transmission 112. The power demand of the machine, disclosed herein, may be an anticipated power demand corresponding to the pre-defined threshold time T. The power demand may be computed by the controller 118 using one or more methods known in the art. In one exemplary embodiment, the power demand may be computed from the rate of change of speed at the transmission output.

### INDUSTRIAL APPLICABILITY

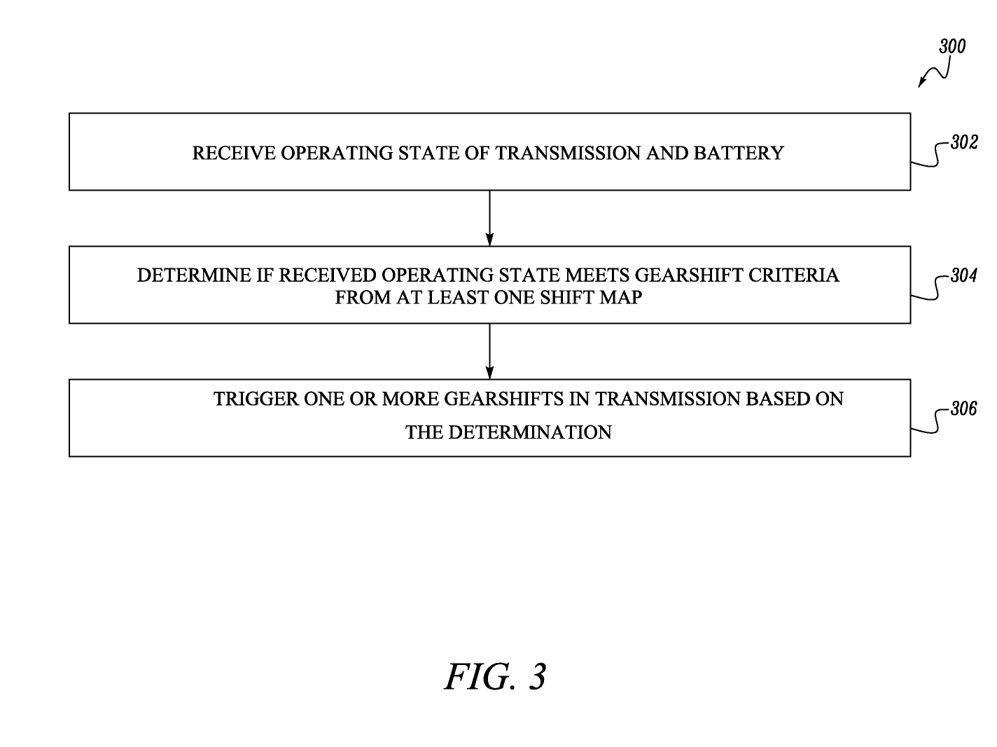

FIG. 3 illustrates a method 300 of controlling gearshifts in a transmission 112 of the hybrid powertrain 100. At step 302, the method 300 includes receiving an operating state of the transmission 112 and the hybrid system 106. As disclosed herein, the operating state of the transmission 112 includes the rate of change of speed at the transmission output while the operating state of the hybrid system 106 includes the peak power check of the hybrid system 106.

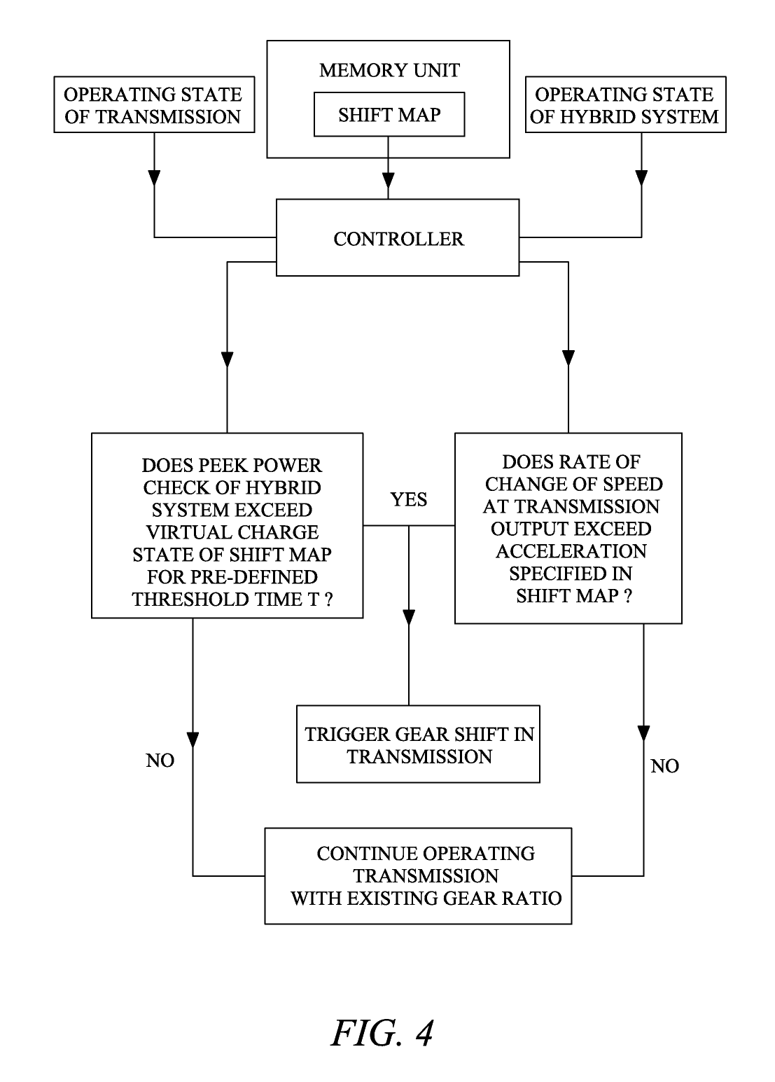

At step 304, the method 300 further includes determining if the received operating state meets the gearshift criteria from the shift map 120. Referring to FIG. 4, an exemplary flow-chart is rendered to explain the working of the control system 114 in conjunction with the shift map 120. As disclosed earlier herein, the memory unit 116 is configured to store the shift map 120. The controller 118 is coupled to the memory unit 116, the transmission 112, and the hybrid system 106. Upon receipt of the operating states at the controller 118, the controller 118 may subsequently determine if the received operating states, i.e. rate of change of speed at the transmission output and the peak power check of the hybrid system 106, meet the gearshift criteria presented in the plot P of the shift map 120. In an exemplary embodiment, the controller 118 may look up the shift map 120 from the memory unit 116 and compare the received operating states therewith.

Turning back to FIG. 3, at step 306, the method 300 further includes triggering one or more gearshifts in the hybrid powertrain 100 based on the determination. Specifically, the controller 118 may trigger upshifts in the transmission 112 of the hybrid powertrain 100 if the operating states meet the gearshift criteria i.e. rate of change of speed at the transmission output and peak power check of the hybrid system 106 exceed the threshold values of acceleration and virtual charge state from the shift map 120 respectively. Further, in an embodiment of the present disclosure, the method 300 includes determining if the operating state satisfies the gearshift criteria for the pre-defined threshold time T.

As shown in FIG. 4, if the rate of change of speed at the transmission output and peak power check of the hybrid system 106 exceed the threshold values of acceleration and virtual charge state of the shift map 120 for the pre-defined threshold time T, then the controller 118 may be configured to trigger an upshift in the transmission 112. However, if the rate of change of speed and peak power check do not exceed the threshold values of acceleration and virtual charge state specified in the plot P of the shift map 120 for the pre-defined threshold time T, then the controller 118 is not configured to trigger an upshift in the transmission 112.

Conventional gear control apparatuses typically operate by triggering gearshifts based on instantaneous operating parameters of a hybrid powertrain. Although, such operation may bring about a real-time change in the gear ratios and configure the hybrid powertrain to meet the power demands of the machine, such operation may consequently entail too many gearshifts in a given span of time during operation of a machine. Consequently, such operation may lead to detrimental effects such as wear and/or premature failure of components associated with the transmission, for example, a clutch. A person having ordinary skill in the art that such detrimental effects entail repairs, replacement, downtime of the machine and incur additional costs associated thereto.

As disclosed earlier herein, the pre-defined time may be in the range of 1 second to 99 seconds. In one embodiment as shown in FIG. 2, the pre-defined threshold time T may be 10 seconds. In another embodiment, the pre-defined threshold time T may be 15 seconds. Although it is disclosed herein that the pre-defined threshold time T may be 10 seconds and 15 seconds respectively, it is to be noted that the pre-defined threshold time T is merely exemplary in nature and hence, non-limiting of this disclosure. The pre-defined threshold time T may vary from one hybrid powertrain to another and may depend on specific requirements of an application.

It is to be noted that in various other embodiments of the present disclosure, the pre-defined threshold time T, disclosed herein, may be computed from theoretical models, statistical models, simulation models, or experimental test data pertaining to previous trial runs of the hybrid system 106 and the transmission 112. In some cases, the pre-defined threshold time T may be set to a low value, for example, 3 seconds. In such cases, the controller 118 may be configured to trigger early upshifts in the transmission 112. Such early upshifts may be beneficial when the maximum power output level from the hybrid system 106 is capable of meeting the power demand of the machine for the pre-defined threshold time T. Although early upshifts are allowed to occur in the transmission 112 with the help of the controller 118, the controller 118 may prevent too many gearshifts from occurring within a given span of time due to the pre-defined threshold time T employed therein.

Accordingly, it is contemplated herein that the controller 118 may be preset with an optimal value of the pre-defined threshold time T so that the controller 118 is configured to perform early upshifts in the transmission 112 while being prevented from executing too many gearshifts in a given span of time. Therefore, with implementation of the control system 114 disclosed herein, the transmission 112 may configure the hybrid powertrain 100 to deliver optimum output power and meet the power demand of the machine without deteriorating components associated with the transmission 112, for example, the clutch. Further, use of the present control system 114 may mitigate repairs and/or replacement of components associated with the transmission 112. Consequently, costs previously incurred with use of the conventional gear control apparatuses may be offset.

Moreover, implementation of the present control system 114 may be helpful in cases where components of the hybrid powertrain 100 such as the engine 104, the hybrid system 106, or the transmission 112 are manufactured to different specifications or by different manufacturers. The control system 114 of the present disclosure may help in synchronizing the performance of the various components of the hybrid powertrain 100. The pre-defined shift map 120 pre-set in the memory unit 116 may correspond to the specifications of the different components of the hybrid powertrain 100, and thus, allow better control of gearshifts by the control system 114. The controller 118 may be pre-set with any number of such shift maps 120 to correspond to different operating modes of the machine. Some examples of operating modes include, but is not-limited to, an economy mode in which maximum fuel efficiency from the engine 104 is desired, a performance mode in which maximum power at the driveline 102 is desired, or a winter mode in which minimum torque is desired at the driveline 102 to prevent skidding of the machine.

Furthermore, when the specifications of the hybrid powertrain 100 are known beforehand, the control system 114 may be integrally provided with the transmission 112. However, in alternative embodiments, the control system 114 may be implemented as an ECM package and provided for fitment onto the hybrid powertrain 100. In such cases, the memory unit 116 of the control system 114 may be configured to store more than one shift map 120 in order to correspond to different specifications and/or to different operating parameters of the various components of the hybrid powertrain 100. Therefore, assembly personnel may easily configure the control system 114 to trigger gearshifts in the transmission 112 and synergistically transmit power from the hybrid powertrain 100 to the driveline 102 of the machine.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

We claim:

1. A control system for a hybrid powertrain comprising a transmission, and a hybrid system, the control system comprising:
a memory unit configured to store at least one shift map; and
a controller coupled to the memory unit, the transmission, and the hybrid system, the controller configured to:
receive an operating state of the transmission and the hybrid system;
determine if the received operating state meets a gearshift criteria from the at least one shift map; and
trigger one or more gearshifts in the transmission based on the determination.

2. The control system of claim 1, wherein the at least one shift map is a plot of acceleration at the transmission output versus virtual charge state of the hybrid system.

3. The control system of claim 1, wherein the operating state of the hybrid system includes a peak power check of the hybrid system.

4. The control system of claim 1, wherein the controller is further configured to determine if the operating state of the hybrid system satisfies the gearshift criteria for a pre-defined threshold time.

5. The control system of claim 4, wherein the gearshift criteria is satisfied when a peak power check exceeds a virtual charge state of the hybrid system from the shift map for the pre-defined threshold time.

6. The control system of claim 4, wherein the pre-defined threshold time is in a range of 1 second to 99 seconds.

7. The control system of claim 4, wherein the pre-defined threshold time is 10 seconds.

8. The control system of claim 1, wherein the operating state of the transmission includes a rate of change of speed at the transmission output.

9. The control system of claim 8, wherein the gearshift criteria is satisfied when the rate of change of speed at the transmission output is greater than an acceleration of the transmission output from the shift map.

10. The control system of claim 1, wherein the controller is configured to trigger an upshift in the transmission upon determining that the received operating state meets the gearshift criteria.

11. A method of controlling gearshifts in a transmission of a hybrid powertrain, the method comprising:
receiving an operating state of the transmission and a hybrid system;
determining if the received operating state meets a gearshift criteria from at least one shift map; and
triggering one or more gearshifts in the hybrid powertrain based on the determination.

12. The method of claim 11, wherein the shift map is a plot of a rate of change of speed of the transmission output versus a virtual charge state of the hybrid system.

13. The method of claim 11, wherein receiving an operating state of the hybrid system includes performing a peak power check on the hybrid system.

14. The method of claim 11, wherein the method further includes determining if the operating state satisfies the gearshift criteria for a pre-defined threshold time.

15. The method of claim 14, wherein the gearshift criteria is satisfied when a peak power check exceeds a virtual charge state of the hybrid system from the shift map for the pre-defined threshold time.

16. The method of claim 14, wherein the pre-defined threshold time is in a range of 1 second to 99 seconds.

17. The method of claim 14, wherein the pre-defined threshold time is 10 seconds.

18. The method of claim 11, wherein receiving an operating state of the transmission includes receiving a rate of change of speed at the transmission output.

19. The method of claim 18, wherein the gearshift criteria is satisfied when the rate of change of speed at the transmission output is greater than an acceleration of the transmission output in the shift map.

20. The method of claim 11, wherein the triggering of one or more gearshifts includes upshifting a gear position in the transmission upon determining that the received operating state meets the gearshift criteria.
